(19) United States
(12) Patent Application Publication
(10) Pub. No.: US 2018/0096433 A1
(43) Pub. Date: Apr. 5, 2018

(54) Calculation of Differential for Insurance Rates

(71) Applicant: AT&T Intellectual Property I, L.P., Atlanta, GA (US)

(72) Inventors: Steven Belz, Sunnyvale, TX (US); James H. Pratt, Round Rock, TX (US); Marc Andrew Sullivan, Austin, TX (US)

(21) Appl. No.: 15/284,174

(22) Filed: Oct. 3, 2016

(51) Int. Cl. G06Q 40/08; G07C 5/02; G06K 9/00; H04N 7/18

(52) U.S. Cl. CPC G06Q 40/08; G07C 5/02; G06K 9/00791; G06K 2209/15; H04N 7/183; H04N 7/188; G06K 2009/00738; G06K 9/00718

(57) ABSTRACT

A system includes an input processor configured to receive video data from a source, wherein the video data includes identifiable data associated with a first vehicle, an analytics engine in communication with the input processor, wherein the analytics engine in configured to determine the identity of the first vehicle based on the identifiable data, a database in communication with the analytics engine wherein the database contains historical data associated with the first vehicle and the analytics engine uses the historical data in analyzing the video data, and an output processor configured to generate driving metrics based on the analyzed video data.

### TECHNICAL FIELD

Embodiments of the present inventions relate to methods and systems for collecting driver data, and more particularly to methods and systems that uses cameras and optical character recognition software to identify at-risk drivers for insurance purposes.

### BACKGROUND

Insurance companies have been collecting real-time driving information to supplement its underwriting policies to accurately price insurance premiums in view of the risk associated with those policies. Examples of this technology include insurance companies offering drivers discounts if they are willing to put ‘black boxes’ in their vehicles to verify their driving behavior. The problem with this approach is one of self-selection. Specifically, drivers who suspect they may not benefit from this technology are not apt to include it on their vehicles. Thus, there is a need for a system and method for capturing driver data and providing that driver data to insurers.

### SUMMARY

The disclosure is directed to a system and method for capturing data and calculating risk associated with driving behavior for a variety of uses, including for calculating insurance rates. The system includes an input processor configured to receive video data from a source, wherein the video data includes identifiable data associated with a first vehicle, an analytics engine in communication with the input processor, wherein the analytics engine in configured to determine the identity of the first vehicle based on the identifiable data, a database in communication with the analytics engine wherein the database contains historical data associated with the first vehicle and the analytics engine uses the historical data in analyzing the video data, and an output processor configured to generate driving metrics based on the analyzed video data. The source may be a camera mounted on a second vehicle or may be stationary and may further include an event history database that includes event data on vehicles similar to the first vehicle, the event history database in communication with the analytics engine and wherein the analytics engine is further configured to analyze the video data using the event data and wherein the output processor is configured to communicate with an external server. The system may receive data wirelessly from a cellular system.

The method of the present disclosure may include receiving, by a processor, video data from a source, wherein the video data includes identifiable data associated with a first vehicle, determining, by the processor, the identity of the first vehicle, accessing, by the processor, historical data associated with the first vehicle, analyzing, by the processor, the video data in view of the historical data, and generating, by the processor, driving metrics for the first vehicle based on the analyzing step. The method may further include validating the location of the first vehicle, accessing an event history database comprising event data on vehicles similar to the first vehicle and wherein the analyzing step includes analyzing the event data. In an aspect, the method may include wherein the event history database comprises geographical data associated with the event data or traffic data associated with the event data. In an aspect, the source may be a second vehicle and the method may include collecting data associated with the second vehicle. In an aspect, the generating step may include generating driving metrics associated with the second vehicle and sending the driving metrics for the first vehicle and/or the second vehicle to a server.

The disclosure is also directed to a server having an input/output for communicatively coupling the server to a source, a processor communicatively coupled to the input/output system, and memory storing instructions that cause the processor to effectuate operations, the operations including receiving video data from the source, wherein the video data includes identifiable data associated with a first vehicle, determining the identity of the first vehicle, accessing historical data associated with the first vehicle, analyzing the processor the video data in view of the historical data, and generating driving metrics for the first vehicle based on the analyzing step. In an aspect, the operations may further include validating the location of the first vehicle, and accessing an event history database comprising event data on vehicles similar to the first vehicle and wherein the analyzing step includes analyzing the event data. In an aspect, the source may be a second vehicle and the operations may further include collecting data associated with the second vehicle. In an aspect, the operations may further include sending the driving metrics for the first vehicle to a second server

### BRIEF DESCRIPTION OF THE DRAWINGS

The following detailed description of preferred embodiments is better understood when read in conjunction with the appended drawings. For the purposes of illustration, there is shown in the drawings exemplary embodiments; however, the subject matter is not limited to the specific elements and instrumentalities disclosed. In the drawings:

FIG. 1 is a schematic representation of an exemplary system environment in which the methods and systems to capture driver data may be implemented.

FIG. 2 is a functional block diagram of an exemplary system in which methods and systems to capture and analyze driver data may be implemented.

FIG. 3 is a functional block diagram of an exemplary server configuration shown in FIG. 2.

FIG. 4 is an exemplary process flow in accordance with the present disclosure.

### DETAILED DESCRIPTION OF ILLUSTRATIVE EMBODIMENTS

Overview. The present disclosure may assist insurance carriers in managing risk by increasing the overall visibility into driver behavior as a supplement to its other risk management analyses, processes and procedures. The disclosure includes recording traffic events from vehicles having monitoring cameras onboard which are capable of recording adverse driving behavior of other vehicles and capturing the license plates of those other vehicles and forwarding the information to a server for additional processing and analysis.

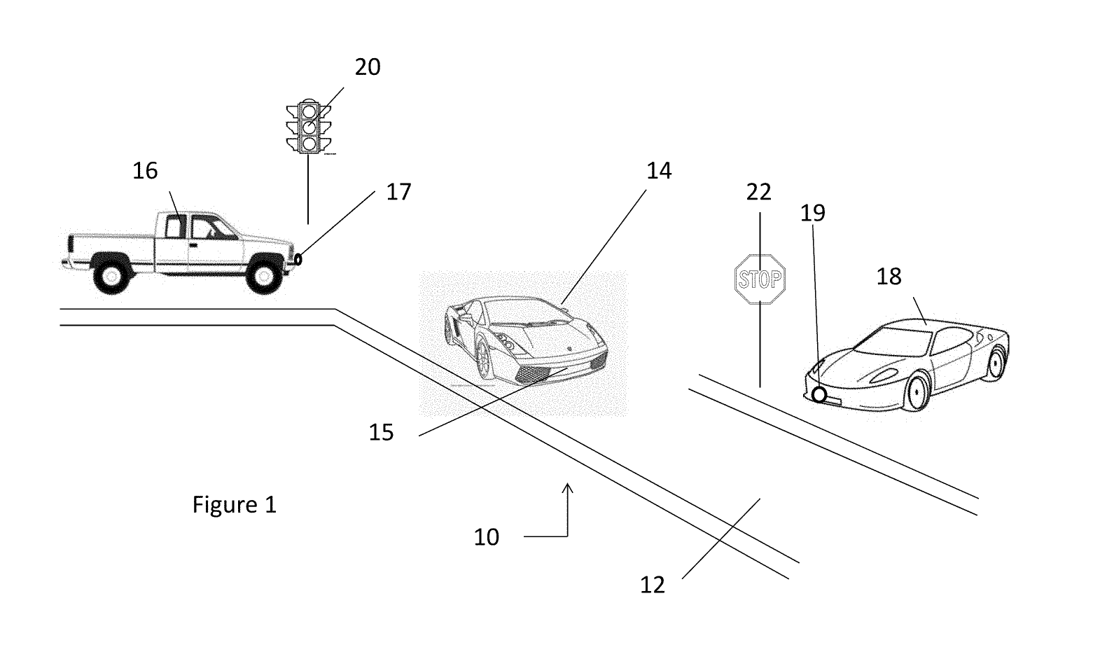

System Environment. Illustrated in FIG. 1 is a schematic representation of an exemplary system environment 10 in which embodiments of the present disclosure may operate. There is shown a road 12, traffic signals 20 and stop sign 22 which collectively forms a representative traffic infrastructure. It will be understood that the traffic infrastructure will include roads, highways, parking lots, traffic signals, traffic signs, railroad tracks, sidewalks, cross-walks, construction warnings, and any other system or apparatus that forms a traffic infrastructure in a community, region, state or nation.

There is also shown a first vehicle 16 (shown in FIG. 1 as a pick-up truck) having a forward-facing camera 17 mounted on the front of the first vehicle 16. It will be understood that the location of the forward-facing camera 17 is exemplary only and cameras may be mounted on any portion of vehicle 16, including a rear-facing camera on the back of vehicle 16 or side-facing cameras on one or both sides of vehicle 16. A second vehicle 14 is shown, having a license plate 15 mounted on the front of vehicle 14. It will be understood that a second license plate may be mounted on the rear of vehicle 14. Vehicle A 4 may also have a camera (not shown) mounted anywhere on the vehicle 14. There is also a third vehicle 18 shown, having a front-facing camera 19 mounted thereon. The location and number of vehicles 14, 16 and 18 are exemplary only and not intended to limit the disclosure in any manner.

The cameras 17 19 may be any type of camera capable of recording and storing video information. The cameras 17 19 may be integral to the vehicles 16 18 or added on to the vehicles 17 19 aftermarket. The cameras 17 19 may have a recording medium (not shown) integral to the cameras 17 19 or externally connected to the cameras 17 19. There may also be an event monitor (not shown) integral or external to the cameras 17 19 which triggers the recording and storing of video information upon the detection of a triggering event. A triggering event, may, for example, be a vehicle travelling in excess of the posted speed limit, a vehicle travelling erratically or running a stop sign 22 or traffic light 20. Other dangerous or erratic driving behaviors may be triggering events within the scope of this disclosure. It is also noted that while the examples herein are directed to detecting erratic behavior, it is also possible that triggering events may be based on good, normal or customary driving behavior, for example, vehicles traveling within the speed limit, stopping for school bus loading and unloading, and the like. The trigger may be automatic based on the detection of a triggering event or manually implemented by a driver of a vehicle 16, 18.

In an aspect, first vehicle 16 may record the driving behavior of vehicle 14 using camera 17. If vehicle 14 runs through the traffic light 20 illegally, the camera 17 may record that event and store the event based on the triggering event of an illegal traffic light maneuver. The camera 17 may record and store both the act of vehicle 14 running the traffic light 20, but also the license plate 15 of vehicle 14. Likewise, vehicle 18 may record the driving behavior of the same vehicle 14 using camera 19. Camera 19 may use the same triggering event if the triggering event was in the field of vision of camera 19 at the time of the illegal traffic light maneuver or a different triggering event, which may, for example, vehicle 14 be rolling through stop sign 22 without stopping.

The first vehicle 16 and third vehicle 18 may be connected cars in that they contain onboard diagnostics and other functionality and are capable of communication with one or more servers using a cellular system as set forth below.

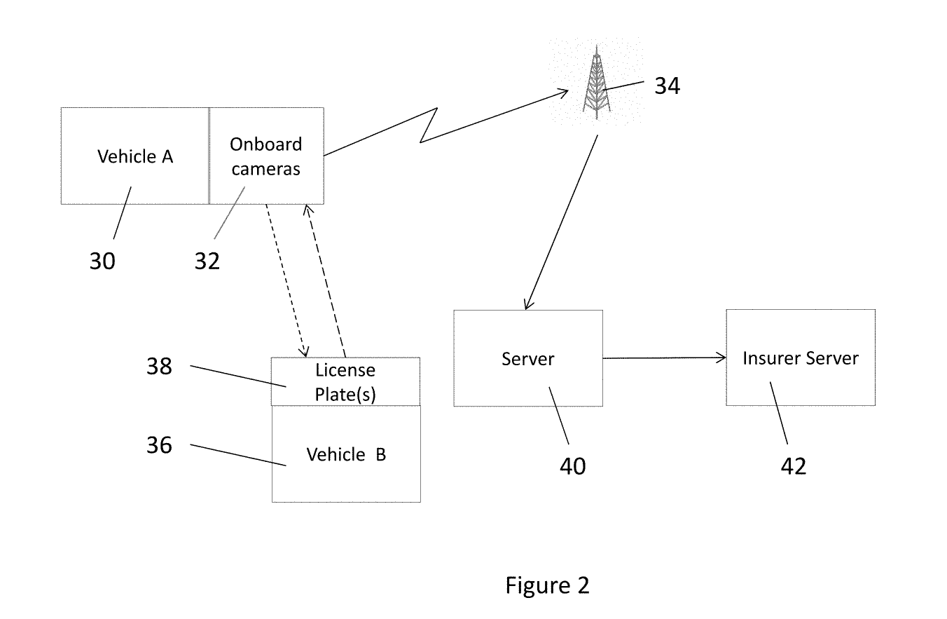

Functional Description. FIG. 2 is an exemplary block diagram illustrating the functionality of the system 10 in FIG. 1. There is shown a representation of vehicle A 30 having onboard cameras 32. There is also shown a representation of vehicle B 36 having a license plate or plates 38. The onboard cameras 32 are shown in visual line of sight communication with license plate 38 to enable the onboard cameras 32 to record both the license plate 38 and the driving behavior of vehicle 36. This line of sight communication is represented by the dashed-lines between onboard cameras 32 and license plates 38

As shown in the example of FIG. 2, vehicle A may use a connected car concept to make the functionality of the onboard cameras 32 accessible by a server 40 in a communication path from vehicle 1 30 to the server 40 through a cellular interface, represented by cellular site 34. The server 40 may be in communication with an insurer's server 42. While the disclosure is described with respect to an insurer is exemplary only. The systems and methods embodied within the disclosure may also include connections to other servers, which may include, without limitation, police reports, safe driving clinics, parents of teen drivers, children of elderly drivers, and other uses.

In a connected car configuration, data from vehicle A 30 may be automatically uploaded to server 40 upon the occurrence of an event, periodically pursuant to a predetermined schedule, or upon command either from vehicle A 30 or server 40. The uploaded data may, for example, include a video recording of an event involving vehicle B 36 and which may also include information relating to the license plates 38 of vehicle B 36. The information relating to the license plates 38 may be simply a photograph of the license plates 38 or may be a tag associated with the video recording of an event. In the case of a tag, an on-board processor may perform some pre-processing of the video record and the license plate photograph to prepare the information for more efficient data transport, which may, for example, including data compression techniques, the use of metatags, and the like. Such preprocessing may also reduce the amount and time of processing to be performed by server 40.

An event may be any traffic event or an event that may impact traffic or the driving behavior of other vehicles. These events may include detection of excessive speed, running a traffic light or stop sign, following too closely, or any other event that is deemed to be risky in view of the traffic, weather, and road conditions. To that end, the on-board cameras may record in a constant manner such that all happenings are captured and at least temporarily stored for later analysis should a traffic event happen. Alternatively, the camera may be equipped with a controller that will detect a triggering event based on certain criteria which will then initiate a recording of past, present or future behavior of vehicles based on the triggering event. In this manner, onboard cameras 32 may be able to record and save video records from a time period just previous to a triggering event, the triggering event itself, and subsequent driving behavior after the triggering event. By also recording the license plate 38 information, a complete video record of the triggering event may be stored for uploading to the server 40.

For example, if vehicle B runs a stop sign, the running of the stop sign may be a triggering event. In addition to recording the license plate 38, the recorded video may include the 2-3 seconds of video prior to vehicle B 36 running the stop sign, the running of the stop sign, and 2-3 seconds of video after vehicle B 36 runs the stop sign. The connected car may be programmed to automatically transmit the recorded video to server 40 upon completion of the recording, or it may periodically transmit the recorded video pursuant to an on-board command from vehicle A 30 or upon a periodic schedule.

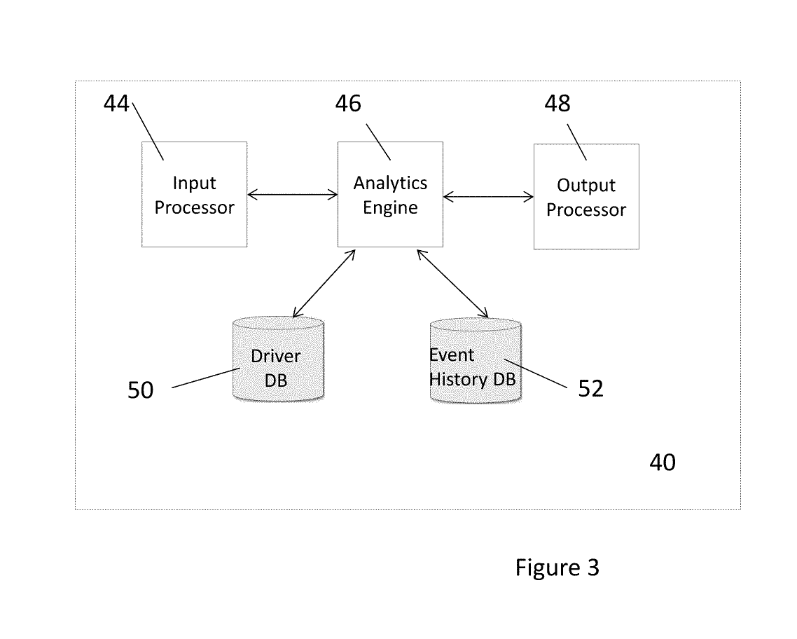

With reference to FIG. 3, there is shown a functional representation of server 40. Within server 40 there may be an input processor 44, an analytics engine 46, and an output processor 48. There also may be a driver database 50 and an event history database 52. Each of these functional components may be in communication with each other through the analytics engine 46.

The input processor may be configured to interface with the cellular system 34. This may be through a wired or wireless communication path. The input processor may be programmed to process the recorded video inputs from vehicle A 30. Such processing may include functions such as identifying the license plates 38 and associating the license plates 38 with the recorded triggering event. The processing may also include receiving multiple formats of data and normalizing the data into a standard format for further processing by the analytics engine 46.

The analytics engine 46 may provide further processing by accessing the historical driving record of an individual driver (to the extent that the identity of the driver may be determined from the license plates 38) from the driver database 50. To the extent that the identity of the driver is not determinable, for example, in the case in which multiple drivers drive the same vehicle, then the analytics engine 56 may access historical driving record from the driver database 50 for that vehicle across all drivers. The historical database 50 may include driver history from publically available sources such as police or court records, accident or repair records, or other information about a driver or a vehicle. The historical database 50 may also include a personal profile of the driver or vehicle, for example, the demographics of the driver such as age, sex, marital status, and other information.

The analytics engine 56 may also access an event history database 52 which may, for example, include driving data of similar vehicles, including that from Vehicle A 30 and Vehicle B 36. That driving data may include, for example, accident data and the causes of such accidents, speeding data, reckless driving data, and the like, as well as external data associated therewith. The external data may include, for example, location data, weather data, time of day, traffic conditions, road conditions such as construction data, and the like.

The analytics engine 56 may process the input data from Vehicle A 30 in view of the relevant data from event history database 52 and driver database 50. The analytics engine may, for example, compare the driving data from Vehicle B 36 to other vehicles of similar makes and models with similar event conditions to determine the riskiness of the most recently recorded driving behavior of Vehicle B 36. The riskiness of the most recently recorded driving behavior of Vehicle B 36 may also be compared to and accumulated with the historical history contained in driver database 50 to generate reports.

The reports may then be accumulated to be sent to an insurance carrier server 42 using output processor 48. The output processor 48 may format the reports compatible with the insurance carrier server 42. As such, the output processor 48 may have APIs associated therewith. As such, the content and format of output reports may be customized for a variety of insurance carrier server 42 interfaces. As such, the same or similar reports may be sent to multiple insurers based on a single incident.

It should be noted that the disclosure is not limited to reporting on the behavior of Vehicle B 36 that has been observed in risky driving situations. The behavior of Vehicle A 30 as captured by internal black boxes or other onboard telematics applications. As such, the analytics engine may also be analyzing data associated with the “near misses” of Vehicle A 30, it being understood that the cumulative driving behavior of Vehicle A 30 may be a factor of the observed behavior of Vehicle B 36.

It should be noted that the examples set forth herein apply to the detection and recording of risky driving behavior. The system and methods of the disclosure would be equally applicable to detect and record behavior that is actually. For example, Vehicle A 30 may observe and record driving behavior of Vehicle B 36 in which Vehicle B 36 has maintained the speed limit for a set period of time or distance may be noteworthy and relevant to insurance carriers.

It should also be noted that while the output processor 48 has been described in relation to interactions with insurance carriers. The system and methods of the disclosure may be equally applicable for reports to law enforcement, state licensing agencies, parent reports on teen driving, or any other purpose.

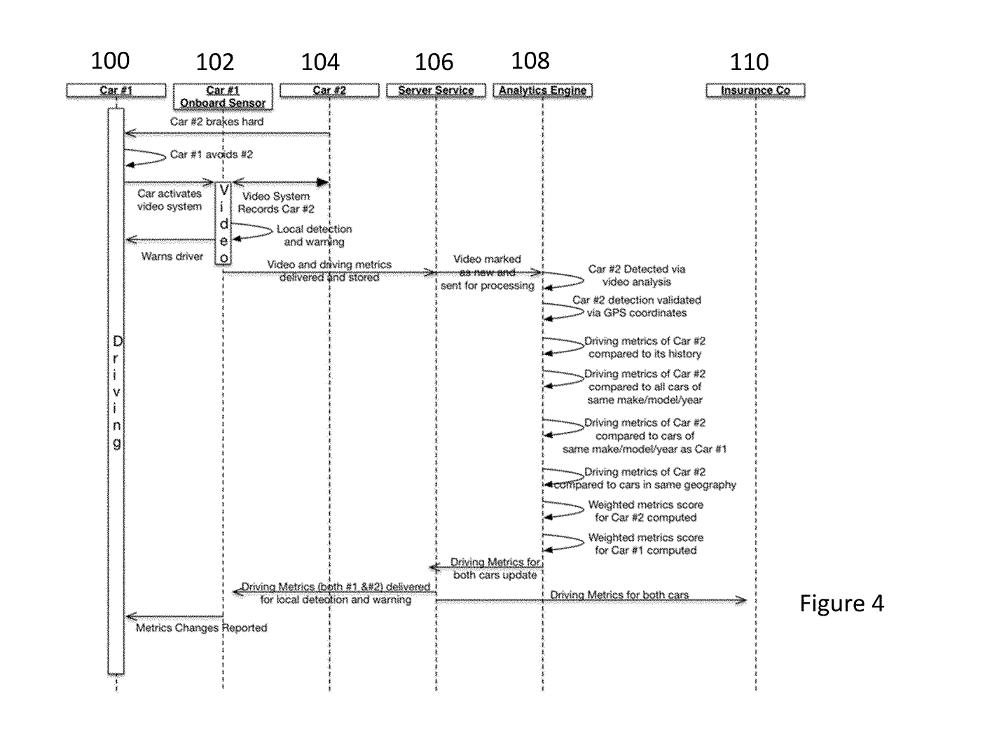

With reference to FIG. 4, there is shown an exemplary and non-limiting process flow for the present disclosure. In this example, column 100 represents Vehicle 1(similar to Vehicle A 30), column 102 represents the onboard sensors of Vehicle, column 104 represents Vehicle 2 (which may be similar to Vehicle B 36), column 106 represents the server service, which may, for example, be server 40, and column 108 represents the analytics engine which may, for example, be analytics engine 46 within server 40, or may be separate from server 40 but in communication with server 40. Finally, column 110 represents the insurer, which may, for example, include insurer server 42.

With respect to the flow represented in FIG. 4, car 2 104 breaks hard and that hard braking event is observed by car 1 100 and car 1 100 provides an avoidance maneuver. The avoidance maneuver is an event that may trigger the video system within onboard sensors 102 to record the behavior of car 2 104. The onboard sensors 102 may also provide a warning to the driver of car 1 100.

Continuing with the process flow, the video system of onboard sensors 102 may package the observed driving metrics of car 2 104 and send the metrics to server 106. The server 106 may mark the metrics as new and then forward to the analytics engine 108. The analytics engine 108 may then provide a variety of functions on the new metrics. While the functions are described herein in an exemplary logical order, such order is not necessary, nor are all of the various functions necessary, to fall within the scope of the appended claims.

For example, the analytics engine 108 may analyze the video data to detect the identity of car 2 104. The detection may be verified by GPS coordinates that were appended to the driving metrics. The driving metrics may then be compared to the historical driving behavior of car 2 and the historical driving metrics of similar vehicles, for example, similar in one or more of vehicle make, model or model year, of both car 1 100 and car 2 104. The driving metrics may also be compared to the driving metrics of other vehicles in the same geographic region. Those other driving geographic metrics may include location, road conditions, weather conditions and other external factors that may affect driving behavior. Such driving metrics may be stored in the external event database 52. For the purposes of this disclosure, unless otherwise specified, event data includes all such information that may be stored in the external event database 52. Based on these comparisons and algorithms which may weigh certain factors more heavily than other factors, the analytics engine may compute a weighted metrics score for each of car 1 100 and car 2 104. The weighted metrics may then be sent to the server 106 for storing in the relevant driver database 50 and external event history database 52. Those weighted metrics may then be sent to the insurer 110 and sent back to car 1 100.

The system and method of the present disclosure may include certain advantages over other onboard diagnostic systems. For example, the outward-facing camera video and recording system records external driving behavior and is able to correlate that information to both the identity of the vehicle exhibiting that driving behavior and customary driving behavior of similarly situated vehicles. The public nature of the video recordings ensures that the problems of self-reporting only positive driving behavior are mitigated.

The systems and method of the present disclosure provide data that is useful across not only the insurance industry, but also in other industries including being used for law enforcement and first responder applications. Public service vehicles may be equipped with external facing cameras, including dash-cams and connected to a network in accordance with the principles of the present disclosure to not only video record events, but also to automatically and/or periodically upload the recorded events and the identity data to servers which then may be programmed to analyze the data and generate reports. The input data and subsequent output reports may be authenticated and verifiable such that the truth and veracity of the input/output may be certified for a variety of uses.

The systems and methods of the present disclosure may be implemented in connection with a safe teen driving program. Parents and schools may subscribe to a service or otherwise request and receive reports on individual teen driving behavior. Not only may insurers may use the output reports to generally and individually rate insurance policies, but schools and parents may use those output reports for training and disciplinary purposes. The systems and methods may be used with other telematics applications such as geo-fencing to provide a complete report of teen driving behavior.

Similarly, an application which tracks driving behavior of individuals whose reflexes may be dimmed due to age, health or injury may also be useful for families or caregivers. Reports involving driving accidents with injuries sustained by individuals may be collected and sent to emergency medical personal, including emergency rooms and hospitals, to provide additional background on the events surrounding the injured individuals. The reports may be useful for auto repair body shops to help detect latent damage which may not otherwise be visible in a normal inspection. These and the other useful examples contained herein are not intended to limit the claims in any manner.

The onboard cameras described herein may also be stationary, which may, for example, include being secured to buildings, traffic signals or independently installed temporarily or permanently and programed using controllers to activate video recordings upon the detection of certain events and upload videos associated with the events to a system configured in accordance with the disclosure.

Although not every conceivable combination of components and methodologies for the purposes describing the present disclosure have been set out above, the examples provided will be sufficient to enable one of ordinary skill in the art to recognize the many combinations and permutations possible in respect of the present disclosure. Accordingly, this disclosure is intended to embrace all such alterations, modifications and variations that fall within the spirit and scope of the appended claims. For example, numerous methodologies for defining triggering events for activation of sensor technologies including onboard video cameras to record risky driving behavior may be encompassed within the concepts of the present disclosure.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the embodiments. In this regard, it will also be recognized that the embodiments includes a system as well as a computer-readable medium having computer-executable instructions for performing the acts and/or events of the various methods.

While example embodiments of an onboard video system to record risky driving behavior of other vehicles have been described in connection with various computing devices/processors, the underlying concepts can be applied to any computing device, processor, or system capable of receiving visual voice mail notifications as described herein. The methods and apparatuses for recording and reporting risky driving behavior, or certain aspects or portions thereof, can take the form of program code (i.e., instructions) embodied in tangible storage media having a physical structure, such as floppy diskettes, CD-ROMs, hard drives, or any other machine-readable storage medium having a physical tangible structure (computer-readable storage medium), wherein, when the program code is loaded into and executed by a machine, such as a computer, the machine becomes an apparatus for distributing connectivity and/or transmission time. A computer-readable storage medium, as described herein is an article of manufacture, and thus, is not to be construed as a transitory signal. In the case of program code execution on programmable computers, which may, for example, include server 40, the computing device will generally include a processor, a storage medium readable by the processor (including volatile and non-volatile memory and/or storage elements), at least one input device, and at least one output device. The program(s) can be implemented in assembly or machine language, if desired. The language can be a compiled or interpreted language, and combined with hardware implementations.

The methods and systems of the present disclosure may be practiced via communications embodied in the form of program code that is transmitted over some transmission medium, such as over electrical wiring or cabling, through fiber optics, wherein, when the program code is received and loaded into and executed by a machine, such as an EPROM, a gate array, a programmable logic device (PLD), a client computer, a controller, or the like, the machine becomes an apparatus for use in reconfiguration of systems constructed in accordance with the present disclosure. When implemented on a general-purpose processor, the program code combines with the processor to provide a unique apparatus that operates to invoke the functionality described herein.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed:

1. A system comprising:
An input processor configured to receive video data from a source, wherein the video data includes identifiable data associated with a first vehicle;
An analytics engine in communication with the input processor, wherein the analytics engine in configured to determine the identity of the first vehicle based on the identifiable data;
A database in communication with the analytics engine wherein the database contains historical data associated with the first vehicle and the analytics engine uses the historical data in analyzing the video data; and
An output processor configured to generate driving metrics based on the analyzed video data.

2. The system of claim 1 wherein the source is a camera mounted on a second vehicle.

3. The system of claim 1 further comprising an event history database comprising event data on vehicles similar to the first vehicle, the event history database in communication with the analytics engine and wherein the analytics engine is further configured to analyze the video data using the event data.

4. The system of claim 4 wherein the output processor is configured to communicate with an external server.

5. The system of claim 1 wherein the input processor is configured to receive video data wirelessly.

6. The system of claim 1 wherein the source is a stationary camera.

7. A method comprising:
Receiving, by a processor, video data from a source, wherein the video data includes identifiable data associated with a first vehicle;
Determining, by the processor, the identity of the first vehicle,
Accessing, by the processor, historical data associated with the first vehicle;
Analyzing, by the processor, the video data in view of the historical data; and
Generating, by the processor, driving metrics for the first vehicle based on the analyzing step.

8. The method of claim 7 further comprising validating the location of the first vehicle.

9. The method of claim 7 further comprising accessing an event history database comprising event data on vehicles similar to the first vehicle and wherein the analyzing step includes analyzing the event data.

10. The method of claim 9 wherein the event history database comprises geographical data associated with the event data.

11. The method of claim 9 wherein the event history database comprises traffic data associated with the event data.

12. The method of claim 7 wherein the source is a second vehicle and further comprising collecting data associated with the second vehicle.

13. The method of claim 12 wherein the generating step includes generating driving metrics associated with the second vehicle.

14. The method of claim 13 further comprising sending the driving metrics for the second vehicle to a server.

15. The method of claim 7 further comprising sending the driving metrics for the first vehicle to a server.

16. A server comprising:
an input/output for communicatively coupling the server to a source;
a processor communicatively coupled to the input/output system; and
memory storing instructions that cause the processor to effectuate operations, the operations comprising:
Receiving video data from the source, wherein the video data includes identifiable data associated with a first vehicle;
Determining the identity of the first vehicle,
Accessing historical data associated with the first vehicle;
Analyzing the processor the video data in view of the historical data; and
Generating driving metrics for the first vehicle based on the analyzing step.

17. The server of claim 16 further comprising validating the location of the first vehicle.

18. The server of claim 16 further comprising accessing an event history database comprising event data on vehicles similar to the first vehicle and wherein the analyzing step includes analyzing the event data.

19. The server of claim 16 further comprising wherein the source is a second vehicle and further comprising collecting data associated with the second vehicle.

20. The server of claim 16 further comprising sending the driving metrics for the first vehicle to a second server.
